(19) United States
(12) Patent Application Publication
(10) Pub. No.: US 2002/0056075 A1
(43) Pub. Date: May 9, 2002

(54) System for a run-time engine capable for pager capable remote device

(76) Inventors: Andrew Hamilton, Reston, VA (US); Joseph Nardone, Arlington, VA (US)

Correspondence Address: WILMER, CUTLER & PICKERING, 2445 M. Street, N.W., Washington, DC, 20037-1420, US

(21) Appl. No.: 09/985,880

(22) Filed: Nov. 6, 2001

Related U.S. Application Data
(60) Provisional application No. 60/245,679, filed on Nov. 6, 2000.

(51) Int. Cl. G06F 9/44

(52) U.S. Cl. 717/110; 717/113

(57) ABSTRACT

A run-time engine may be utilized to execute software applications. In particular, a user may develop customized application utilizing a development tool. The development tool provides a graphical user interface method of creating software application utilizing visual languages such as VISUAL BASIC, VISUAL C, etc. The resulting software application may be a combination of pseudo-code, compiled program scripts, graphical user interface definitions, etc. The software application(s) may be transmitted to a mobile device (e.g., a two-way text pager) for storage and execution. When a user activates the software application on the mobile device, the run-time engine is instantiated and the software application. Accordingly, by executing the run-time engine, the software application may generate screen displays on-the-fly with a minimal amount of storage space required by the software application. Moreover, by run-time engine provides an execution platform for software applications created by a development tool utilizing a visual programming language, thereby increasing the facility of software application development.

### RELATED APPLICATIONS

This application claims priority to U.S. Provisional Application No. 60/245,679, filed Nov. 6,2000, entitled “System For A Run-time Engine Capable For Pager Capable Remote Device”, which is assigned to the assignee of this application. The disclosure of application Ser. No. 60/245,679 is incorporated herein by reference.

### FIELD OF THE INVENTION

The present invention relates generally to run-time engines implemented on remote computing devices such as pager capable wireless handheld devices and the like.

### DESCRIPTION OF THE RELATED ART

Mobile devices (e.g., two-way text pagers, Wireless Application Protocol telephones, etc.) provide users the capability to execute application software similar to application software that a user may have installed on a desktop personal computer. As a result, software developers have continued to create new application software for mobile devices.

For a typical mobile device (e.g., BLACKBERRY by Research In Motion, LTD.,) a software developer may request a software development kit (SDK) from manufacturer of the mobile device. Subsequently, the software developer may utilize the SDK to create application software for the mobile device. However, the software development process is not without its difficulties. For instance, in the case of the BLACKBERRY, the software developer may need extensive knowledge of programming languages (e.g., C++) in order to develop the application software. As a result, the software developer may be required to hire experienced programmers, which may lead to an increase in the cost of the application software. Moreover, since extensive knowledge of a programming language may be required, a typical user may be precluded from developing her own custom application.

In another aspect, some conventional two-way text pagers (e.g., the BLACKBERRY) have unique program execution program requirements. The typical BLACKBERRY application expects that the screens that are to be displayed during the execution of an application to be defined at compile time. However, in order to create the screen definitions at compile time, a developer would have to typically utilize a BLACKBERRY software development kit (SDK), (e.g., BLACKBERRY SDK version 2.0, May 2000, Research In Motion, LTD., which is incorporated in its entirety by reference) to develop the application, and thus the screen definitions. As a result, the developer may require an experienced programmer to develop applications, which may increase the overall costs of an application.

### SUMMARY OF THE INVENTION

In accordance with the principles of the present invention, one aspect of the invention pertains to a method for executing application programs. The method includes receiving at least one application program in a client device and activating at least one application program. The method also includes instantiating a run-time engine and executing at least one application program by the run-time engine.

Another aspect of the present invention relates to a system for executing application programs. The system includes a client device and a run-time engine. The client device includes a memory and a processor. The run-time engine resides in the memory and is executed on the processor. The client is configured to receive at least one application program and is also configured to instantiating the run-time engine in response to an activation of at least one application program. The client is further configured to execute at least one application program by the run-time engine.

Yet another aspect of the present invention pertains to a computer readable storage medium on which is embedded one or more computer programs. The one or more computer programs implement a method of executing application programs. The one or more computer programs comprising a set of instructions for receiving at least one application program in a client device and activating at least one application program. The set of instructions further includes instantiating a run-time engine and executing at least one application program by the run-time engine.

### BRIEF DESCRIPTION OF THE DRAWINGS

Various objects, features, and aspects of the present invention can be more fully appreciated as the same become better understood with reference to the following detailed description of the present invention when considered in connection with the accompanying drawings, in which:

FIG. 1 illustrates an exemplary system in accordance with an embodiment of the present invention;

FIG. 2 illustrates an exemplary class objects utilized by an embodiment of the present invention;

FIG. 3 illustrates an exemplary instantiation of an rt_engine class object shown in FIG. 2 in accordance with an embodiment of the present invention;

FIG. 4 illustrates an exemplary main processing flow diagram implemented by client in accordance with the principles of the present invention;

FIG. 5 illustrates an exemplary flow diagram executed by the client in accordance with an embodiment of the present invention;

FIG. 6 illustrates an exemplary flow diagram of a GO method of the rt_engine_class shown in FIG. 2 in accordance with the principles of the present invention;

FIG. 7 illustrates an exemplary detailed flow diagram for the setup aspect of the GO method of the run-time engine shown in FIGS. 1-3 and 6 in accordance with an embodiment of the present invention;

FIG. 8 illustrates an exemplary flow diagram for a setup for a jump table referred to in FIG. 7 in accordance with the principles of the present invention;

FIG. 9 illustrates an exemplary flow diagram for the database table set-up process referred to in FIG. 7 in accordance with an embodiment of the present invention;

FIG. 10 illustrates an exemplary flow diagram of the process to setup variables referred to in FIG. 7 in accordance with an embodiment of the present invention;

FIG. 11 illustrates an exemplary flow diagram for a setup screen process referred to in FIG. 7 in accordance with an embodiment of the present invention;

FIG. 12 illustrates a more detailed exemplary flow diagram of the build screen process referred to in FIG. 11 in accordance with an embodiment of the present invention;

FIG. 13 illustrates a more detailed exemplary flow diagram of the add TITLE process referred to in FIG. 12 in accordance with an embodiment of the present invention;

FIG. 14 illustrates an exemplary flow diagram for an add MENU process referred to in FIG. 12 in accordance with an embodiment of the present invention;

FIG. 15 illustrates an exemplary flow diagram of an add EDIT process referred to in step 1222 of FIG. 12 in accordance with an embodiment of the present invention;

FIG. 16 illustrates an exemplary flow diagram for a add CHOICE processing referred to in FIG. 12 in accordance with an embodiment of the present invention;

FIG. 17 illustrates an exemplary flow diagram of an add LIST process referred to in FIG. 12 in accordance with an embodiment of the present invention;

FIG. 18 illustrates an exemplary flow diagram of a RUN CODE BLOCK process referred to in FIG. 6 in accordance with an embodiment of the present invention; and

FIG. 19 illustrates an exemplary computing platform where embodiments of the present invention may be practiced.

### DETAILED DESCRIPTION OF A PREFERRED EMBODIMENT

For simplicity and illustrative purposes, the principles of the present invention are described by referring mainly to an exemplary embodiment of a configurable conduit generator module. However, one of ordinary skill in the art would readily recognize that the same principles are equally applicable to, and can be implemented in, all types of systems requiring run-time operation, and that any such variation does not depart from the true spirit and scope of the present invention. Moreover, in the following detailed description, references are made to the accompanying drawings, which illustrate specific embodiments in which the present invention may be practiced. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

In accordance with an embodiment of the present invention, a run-time engine may be utilized to execute software applications. In particular, a user may develop customized application utilizing a development tool. The development tool provides a graphical user interface method of creating software application utilizing visual languages such as VISUAL BASIC, VISUAL C, etc. The resulting software application may be a combination of pseudo-code, compiled program scripts, graphical user interface definitions, etc. The software application(s) may be transmitted to a mobile device (e.g., a two-way text pager) for storage and execution. When a user activates the software application on the mobile device, the run-time engine is instantiated for the software application. Accordingly, by executing the run-time engine, the software application may generate screen displays on-the-fly with a minimal amount of storage space required by the software application. Moreover, the run-time engine provides an execution platform for software application(s) created by a development tool utilizing a visual programming language, thereby increasing the facilitation of software application development.

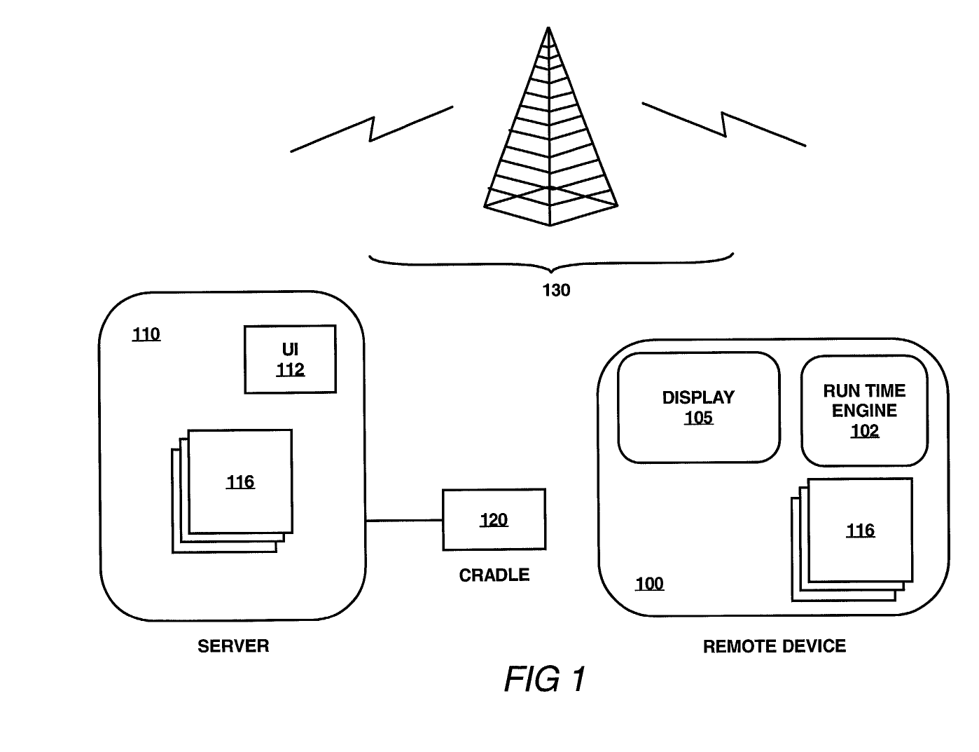

FIG. 1 illustrates an exemplary system 90 in accordance with an embodiment of the present invention. In particular, the system 90 includes a client 100, an application server 110, a client interface 120 (labeled cradle in FIG. 1), and a network 130.

The client 100 may be configured to provide a mobile, untethered computing platform in which to execute software applications. The software applications may include a calendar, a personal information management software, an electronic mail viewer, or a user-customized software application such as inventory control. The client 100 may be implemented on a text-pager, a personal digital assistant, a wireless mobile telephone with or without integrated displays and other similar devices. Examples of a client 100 may include any of a number of pager capable wireless handheld computers or devices such as those offered by Research in Motion, Limited (RIM) of Waterloo, Ontario, Canada, including, for example, RIM 950 Wireless Handheld™ devices running Blackberry Handheld Operating System, Version 2.0 (Blackberry O/S) or the like.

The application server 110 may be configured to provide complementary software applications to the client 100 such as instant messaging application, a web application, a database querying application, and other similar applications. The application server 110 may be implemented by any number of commercially available servers, high performance computers, personal computer or other similar computing platform.

The network 130 may be configured to provide a mobile communication interface between the client 100 and the application server 110. The network 130 may be implemented as a wireless network, a wired network, or a combination thereof. The network 130 may be implemented using protocols such as Transmission Control Protocol/Internet Protocol, X0.25, IEEE 802.5, IEEE 802.3, Asynchronous Transfer Mode, and other network protocols.

In one respect, the client 100 may be configured to interface with the application server 110 via the cradle 120. The cradle 120 may be configured to provide a communication interface between the client 100 and the application server 110 to facilitate the transmission of data therebetween. In this regard, cradle 120 may be connected to application server 110 by a communications link, such as a direct cable connected to a serial port located in application server 110, or the like.

In another respect, the application server 110 may include a user interface development tool 112 (now referred to as a UI). The UI 112 may be configured to function generally as a developmental tool for designing and building application programs 116 to be executed on client 100. For instance, an application designer may utilize UI 112 to design any of the screens that may appear on a display of the client 100, define forms to be displayed, and indicate the source of data for each entry in the form. Similarly, the designer may also dictate or determine the behavior of the application program 116 using a high level programming language such as Visual BASIC or the like. For instance, the designer may generate or input the code or instructions that control the processing of each application program 116. As one example, the designer may wish to allow a user to access a menu display from an introductory screen. Thus, the designer may first draw or design the screen containing a link to the menu display process. Subsequently, the designer may write the code that executes after the menu is accessed by the user.

The client 100 may include a display 105, a run time engine 102, and application programs 116. The display 105 may be configured to provide a visual interface between the application program 116 and a user of the client 100. The run-time engine 102 may be configured to provide a mechanism to initiate and execute the application programs 116 that have been developed for and transmitted to the client 100 from the application server 110.

As contemplated by embodiments of the present invention, any of application programs 116 may be transmitted to the client 100 via the network 130 or cradle 120. In particular, after designing and building an application, the application and/or any related information may be stored or packaged in an application program file and transmitted from the application server 110 to client 100. More specifically, the application program 116 generally includes any application pseudocode or compiled program scripts, graphical user interface definitions, forms or table information, screen and menu definitions, and/or any other related application information, all of which may be embodied in an input data section of a dynamic link library (DLL) file or the like. In addition to this input data section, a small piece of code may be included with the application program file which, in part, is used to call the run-time engine 102. This code may be stored in a code section of the application program file, and may be written in a language native to the client 100, such as C++, or the like. As will be discussed below, upon execution of the application program file, this code may be utilized to pass a pointer to the run-time engine 102, which in turn locates or points to the data or input data section of the application program file.

After transmission, each of application programs 116 may appear as an executable file on display 105. To execute one of these application programs 116, an icon representing the application, for example, may be selected. In response, the selected application program i 16 locates and calls the run-time engine 102, which in turn assumes responsibility for executing the application. More specifically, after an application program 116 is launched, the run-time engine 102 retrieves and executes the instructions and information stored in the data section of the application program file. In addition to these instructions, the run-time engine 102 also utilizes information such as screen definitions, menu definitions, and other program scripts to implement the logic of the application. Furthermore, as will be discussed below, much of the code that actually runs the application may be implemented in the run-time engine 102. To take an insert command as an example, the insert instruction may appear as a simple one line BASIC command. However, execution of the command may require hundreds of run-time instructions. As a result, only a small amount of custom code need be generated by the designer and included with the application program file to effectuate a particular function.

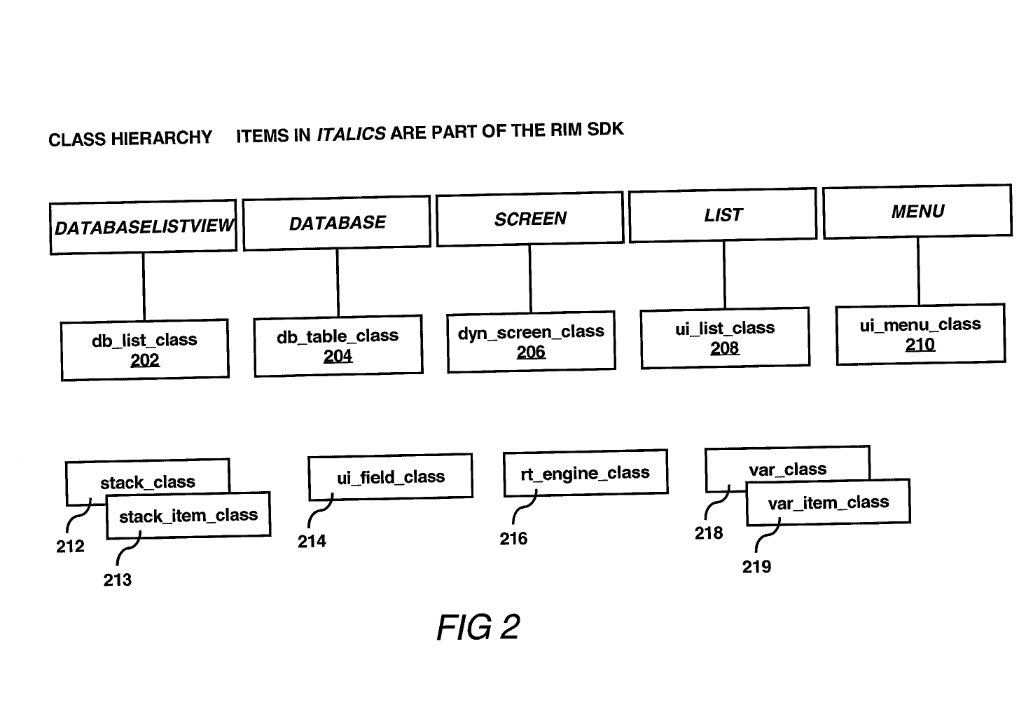

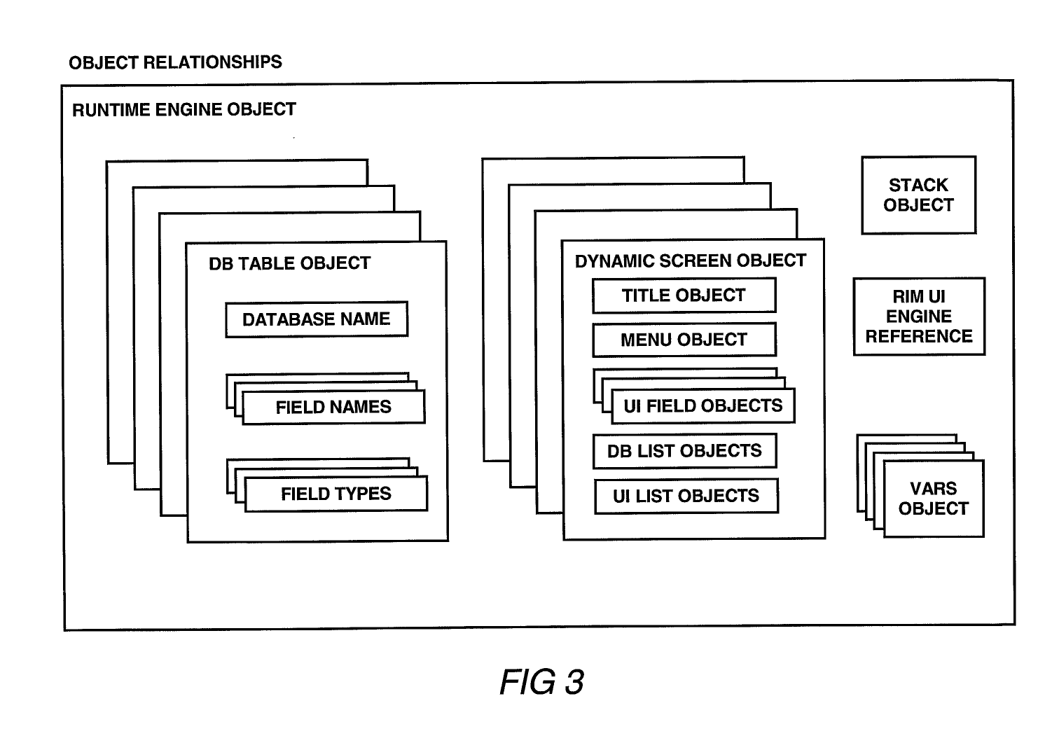

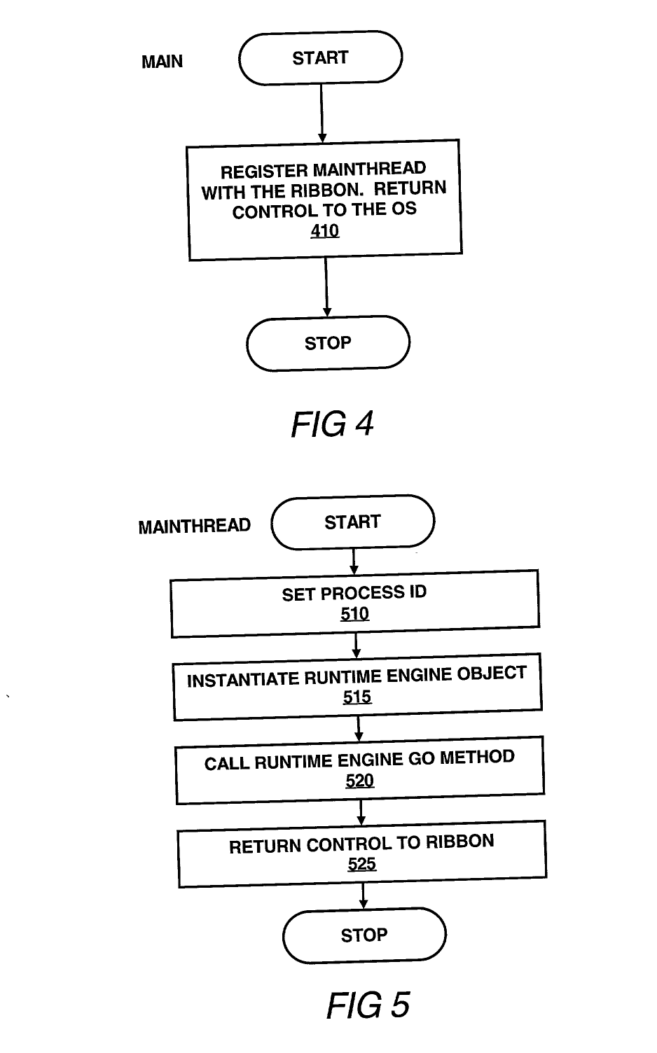

As contemplated by various embodiments of the present invention, the run-time engine 102 adds a number of features or functionalities to existing or native objects offered by the device operating system. In one example, a number of objects are provided or supported by the run-time engine 102 by inheriting from a number of native Blackberry O/S objects. Thus, various embodiments of the present invention contemplate providing a number of enhanced objects offering all of the functionality of the Blackberry O/S objects but also with additional functionality. The objects utilized in this example are first introduced below with reference to FIGS. 2 and 3, and then discussed in greater detail with reference to FIGS. 4-18.

FIG. 2 illustrates exemplary class objects utilized by an embodiment of the present invention. As shown in FIG. 2, a db_list_class 202 object inherits from a DatabaseListView class, and adds a pointer to a ui_list_class object. This allows the db_list_class object 202 to be tightly coupled to a corresponding ui list 208. The db_list_class object 202 includes a method to allow the ui_list pointer to be set to point to a particular ui_list during initialization. The db_list_class also implements the following virtual functions from the DatabaseListView class, each of which is discussed below: insert, insert_at, delete_handle, update, and reset_view.

The DatabaseListView version of “insert” inserts a new record at the end of the db list. The db_list_class 202 is enhanced to insert a record at the end of the corresponding “ui_list”. The DatabaseListView version of “insert_at” inserts a new record at a given index in the db list. The db_list_class 202 is enhanced to insert a record at the given index in the corresponding “ui list”. The DatabaseListView version of “delete_handle” deletes a record from the db list as specified by a record handle. The db_list_class 202 is enhanced to delete the record from the corresponding “ui list”. The DatabaseListView version of update is called by the system when the contents of a particular record have changed in the database. The db_list_class 202 is enhanced to cause the corresponding “ui list” to be redrawn to reflect this change. The DatabaseListView version of “reset_view” reinitializes the db list to be empty. The db_list_class 202 is enhanced to reset the corresponding “ui list” to be empty.

A db_table_class 204 inherits from a RIM Database class and adds several extra fields which are important in defining and keeping track of the structure and status of the database. These include a field for the name of the database, a field that keeps track of the record that is currently being used by the runtime engine 102, a field indicating the number of columns (database fields) in the database, an array field indicating the name of each column, and an array field indicating the type of each column (e.g., string, integer, time, date, etc.). A method is also included to get a handle to the current record, and a method to get the number of a column (database field) given its ASCII name.

A dyn screen_class 206 inherits from a RIM Screen class and implements a dynamically modifiable version of a RIM Screen object. The dyn_screen_class 206 includes a reference to the RIM UIEngine object, a RIM Title object, a ui_menu_class 210 object, an linked list of ui_field_class 214 objects, a screen id, a number representing the code block that should be executed before the screen is painted, and a pointer to the db_list_class 202 and ui_list_class objects, 202 and 208, respectively, if any, that are associated with the screen. Methods for adding a title, menu, edit box(es), choice box(es), and a list are also included. These methods populate the appropriate data fields and call the appropriate RIM methods (AddField, AddLabel) as necessary to dynamically add the requested ui fields to the screen. The inclusion of these extra pointers, references, values, and methods allows for flexible data storage and addition of screen fields during runtime that could otherwise only be done at compile time. Hence, screens can be built from scratch even after the program has started running.

A ui_list_class 208 inherits from a RIM List class and adds references to db_list_class 202 and db_table_class 204 while also adding a function body for the RIM List class pure virtual function, “NowDisplaying”. This implementation of the NowDisplaying function tells the user interface where to find the data represented by each line in the ui list, and indicates how the data should be formatted for display. This ui_list_class 208 implementation also adds a title line to the list, showing the name of each column (database field).

A ui_menu class 210 inherits from a RIM Menu class and adds data storage for menu item texts and IDs as well as a count of a number of menu items. A method is also included for getting the ID of the currently selected menu item. Another method is included which allows the text, ids, and size of the menu to be dynamically set at runtime by automatically allocating and/or deallocating memory for the arrays that hold the menu item ids and menu item text, and by calling the RIM SetMenultems method.

A stack_class 212 and stack_item_class 213 are used for storing return data for function calls and subroutine jumps. The stack may be implemented as a simple array of pointers to stack item objects. A moving pointer keeps track of the size of the stack. The stack item object is a structure that holds the return program counter. Methods for push (add an item to the stack), pop (remove an item from the stack), and peek (look at an item on the stack without removing it) are also included.

An ui_field_class 214 is a linked list object and contains a pointer to a RIM Field object (edit or choice) and supporting data including field id, number of choices (if any), choice item strings (if any), storage space for any label text, and a pointer to the next “ui_field_class” object in the linked list. Separate constructors are included for choice and edit boxes. The edit box constructor populates the ID, label, and pointer to next list object, and creates a new RIM Edit object, setting the RIM Field object pointer to point to it. The choice box constructor allocates memory for and populates the choice item strings array, populates the ID, label, number of choices, and next list object, and creates a new RIM Choice object, setting the RIM Field pointer to point to it.

A var_class 218 represents one variable (either array or scalar). It contains an array of var_item_class 219 object pointers, the number of array dimensions (if any), an array containing the size of each dimension (if any), and the total number of elements. The constructor is designed to read specification data (num dimensions, data type, size of each dimension) directly from the compiled input data given a pointer to the specs for a particular variable.

The var_item_class 219 represents an individual variable element (1 of 1 if the variable is scalar, one of many if the variable is an array). It contains a union of an integer and a character pointer, allowing either representation depending on the data type. It also contains a default constructor which creates an uninitialized variable, a constructor which takes a type parameter and initializes the variable to 0 if numerical or null terminated if string, and a copy constructor. Other methods include comparison operators for equal, not equal, less than, less than or equal, greater than, and greater than or equal, and methods for addition, subtraction, multiplication, and division. Methods for returning the data contained in the union as either a numerical value or a string are also included.

FIG. 3 illustrates an exemplary instantiation of an rt_engine class 216 shown in FIG. 2 in accordance with an embodiment of the present invention. As shown in FIG. 3, the rt_engine_class 216 object may be instantiated for each application program upon execution and contains a pointer to the base address of the compiled data, an array of pointers to db_table_class 204 objects, an array of pointers to dyn_{—screen_class 206 objects, the id of the initial screen, an array of pointers to var_class 218 objects, a method for getting the current screen pointer, methods for setting up database, objects, screen objects, and various objects, a method for initializing a jump table to internal opcode functions, a method for running a code block, a reference to the RIM UIEngine, a stack_class 212 object, a program counter, an offset to the current code block (if any), the current screen id, the current screen pointer, methods for extracting information from the compiled data, a method for looking up the offset to a user defined function, and a method for getting a pointer to a db_table class 204 object given the name of the database.}

The rt_engine_class 216 also includes a “Go” method which serves as the main event loop and function dispatch center. The “Go” method is responsible for calling helper functions to set up initial variables and objects, draw screens, wait for menu selections, and run the appropriate code blocks based on those menu selections. The functionality of the “Go” method and its helper functions are described in detail below with the accompanying flowcharts.

Embodiments of the invention contemplate that the run-time engine implemented according to the example of FIGS. 2-3 may be able to instantiate screen objects and define the details of the screen objects at run-time. Upon instantiation, the above classes contain empty pointers and/or arrays of pointers. Subsequently, upon parsing the compiled script code from the application program file, the run-time engine 102 may determine not only how many of these objects to instantiate, but also which pointers to be allocated and filled with data. Once these objects are created, run-time engine 102 passes them to, for example, the native RIM UI Engine or the like, which may then process and draw the objects as if they had been defined at compile time.

In addition, as will be discussed below, embodiments of the invention contemplate utilizing a single event or “Go” loop to process code from the application program file for all objects. Thus, the dynamic objects of the present invention serve as data-stores for screen-rendering information. As such, these objects typically do not contain their own methods or event loops.

FIG. 4 illustrates an exemplary main processing flow diagram 400 implemented by client 100 in accordance with the principles of the present invention. As shown in FIG. 4, As the client 100 is activated, each application program 116 (see FIG. 1) transferred to client 100 is registered with an operating system of the client 100 (step 410). In particular, an icon is created and displayed on display 105 for each registered application program 116. Subsequently, the client 100 may return to an idle state. Accordingly, an icon representing one of the application programs 116 may be selected by a user to launch the selected application program 116.

FIG. 5 illustrates an exemplary flow diagram 500 executed by the client 100 in accordance with an embodiment of the present invention. As shown in FIG. 5, the client 100 may be configured to set a process identification (ID) corresponding to the selected application program (step 510) in response to an activation of the selected application program. Subsequently, the client 100 may be configured to instantiate a run-time engine 102 from the rt_engine_class 216 (step 515).

The client 100 may be further configured to execute the GO method of the rt_engine class 216, which will be discussed in greater detail hereinbelow (step 520). After the run-time engine 102 completes execution of the GO method, the run-time engine 102 deactivates and control is returned to the operating system of the client 100 (step 525).

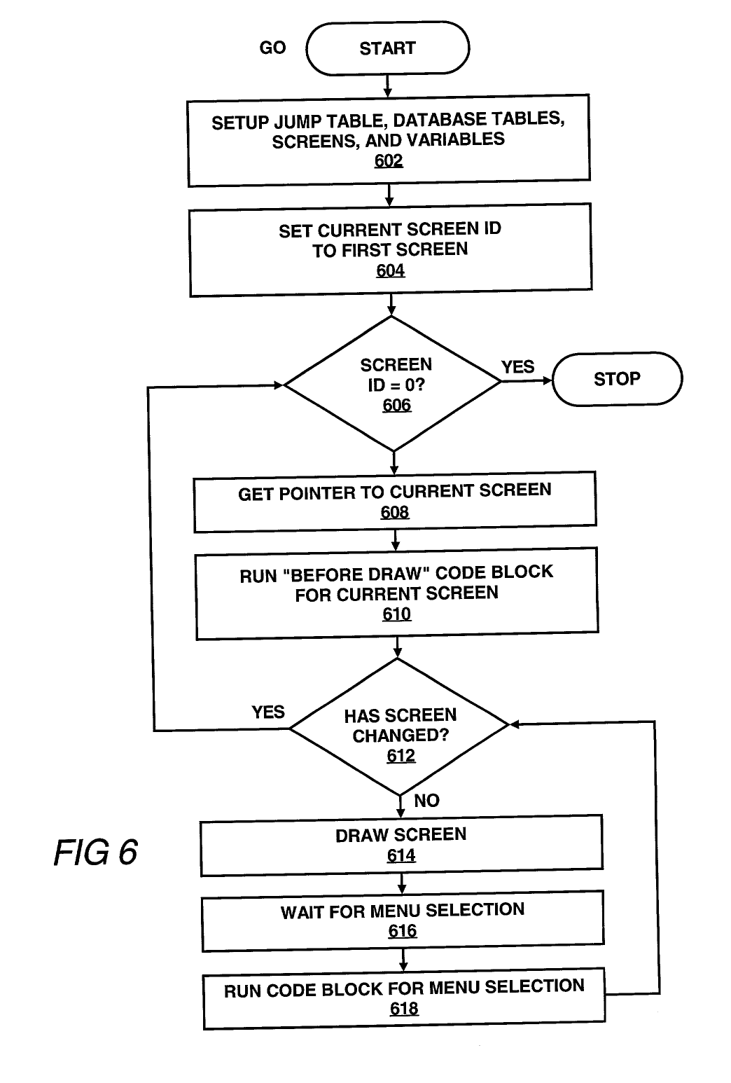

FIG. 6 illustrates an exemplary flow diagram 600 of a GO method of the rt_engine_class 216 shown in FIG. 2 in accordance with the principles of the present invention. Although, for illustrative purposes only, FIG. 6 illustrates a flow diagram for the GO method with the following steps, it should be readily apparent to those of ordinary skill in the art that FIG. 6 represents a generalized illustration of an embodiment of the GO method of the rt engine_class 216 and that other steps may be added or existing steps may be removed without departing from the spirit or scope of the present invention.

As shown in FIG. 6, the run-engine 102 may be configured to execute the GO method in response to an activation of a selected application program. In particular, (step 602) the run-time engine 102 may be configured to initialize any jump tables, database tables, variables, and screens as specified by the activated selected application program. In addition, as mentioned above, a pointer pointing to a data section of the selected application program may be passed to run-time engine 102.

After this initial set-up step, a current screen ID is set to a first screen designated by the developer, for displaying an initial application screen (in step 604). The run-time engine 102 may be configured to check the current screen ID (step 606). If the run-time engine 102 determine that the current screen ID is set to zero, the run-time engine 102 may be cease execution of the GO method. This is primarily for use later on in the process. As an example, when a function wants to terminate execution of the program, it simply requests that screen zero be drawn. Since there is no screen with an ID of zero, the runtime engine knows that this is really a request to halt the program. Subsequently, the run-time engine 102 may deactivate and the control returns to the operating system of the client 100 (see FIG. 5).

Otherwise, if the current screen is not set to zero, in step 606, the run-time engine 102 may be configured to retrieve the current screen by utilizing a pointer that is pointed to the current screen (step 608). By doing so, any data structures utilized by the retrieved current screen are allocated. Subsequently, any “before draw” code may be executed ( step 610).

After the execution of any “before draw” code, run-time engine 102 may be configured to determine whether the retrieved current screen has changed, in step 612. If the retrieved current screen had changed, the run-time engine 102 may be configured to return to the processing of step 606. Otherwise, if the retrieved current screen has not changed, the run-time engine 102 may be configured to display the retrieved current screen including all the screen elements (e.g., menus, icons, and the like) specified by the current screen, in step 614.

The run-time engine 102 may be configured to wait for an action from the user, such as inputting data, selecting a menu item, or editing information (step 616). Subsequently, an action on the part of the user causes the execution of any block code associated with the user's action (step 618). For instance, if the user executes a synchronization command, the code associated with the synchronization command may be run.

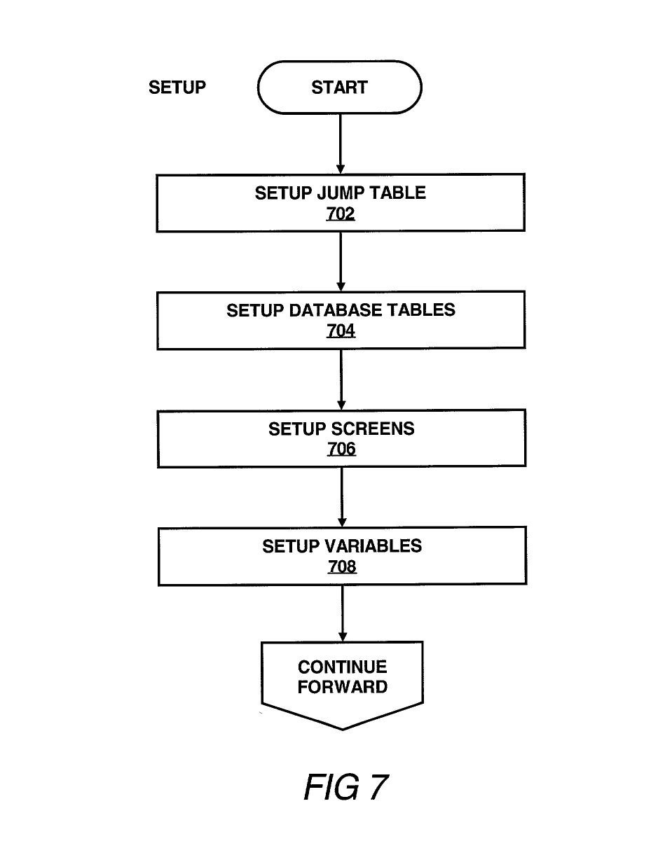

FIG. 7 illustrates an exemplary detailed flow diagram for the setup aspect of the GO method of the run-time engine 102 shown in FIGS. 1-3 and 6 in accordance with an embodiment of the present invention. Although, for illustrative purposes only, FIG. 7 illustrates a flow diagram for the setup aspect of the GO method of the run-time engine 102 with the following steps, it should be readily apparent to those of ordinary skill in the art that FIG. 7 represents a generalized illustration of an embodiment of the setup (step 602) for the run-time engine 102 and that other steps may be added or existing steps may be removed without departing from the spirit or scope of the present invention.

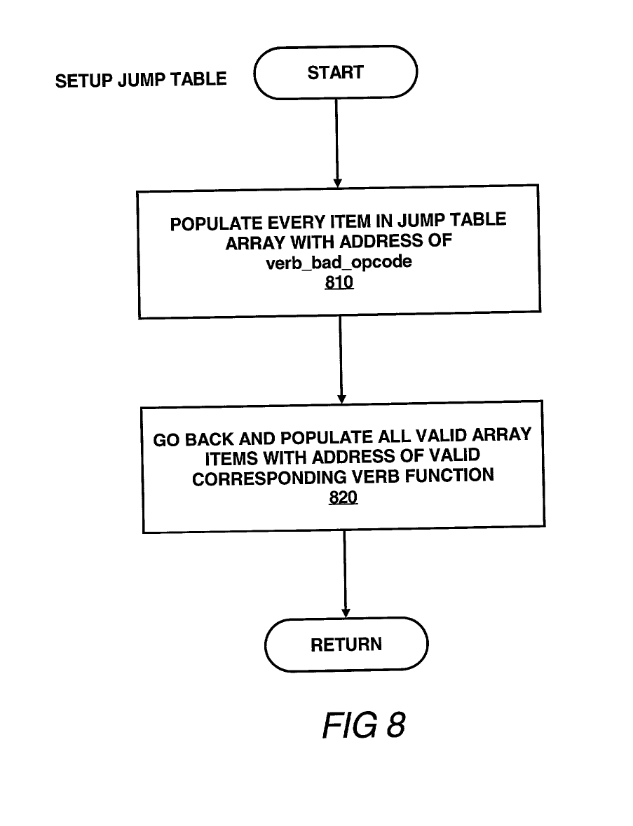

As shown in FIG. 7, the run-time engine 102 may be configured to initialize and allocate memory space for any jump tables required by the selected application program, in step 702. Similarly, the run-time engine 102 may be configured to initialize and allocate memory space for any database tables, setup screens and setup variables, in steps 704-708, respectively. Each of the listed actions by the run-time engine 102 is described in greater detail in FIGS. 8-12.

FIG. 8 illustrates an exemplary flow diagram for a setup for a jump table as shown in step 702 in FIG. 7 in accordance with the principles of the present invention. As shown in FIG. 8, the run-time engine 102 may be configured to initialize a jump table. In particular, the jump table may be configured to provide a listing of pointers. Each pointer configured to point to each valid function used to perform a command or instruction may be created as specified by the selection application program. To accomplish this, each function utilized in the application program is assigned an operation code or op code and arranged in the jump table. Each function or item in the jump table is then populated with the address indicating the existence of a bad or invalid op code (step 8 10). From there, each valid array function or item is populated with an address from run-time engine 102 corresponding to that of the particular function (step 820). Thus, during the execution of an application, valid function calls are sent to their appropriate run-time engine location whereas invalid calls result in, for example, the display of bad op code error messages.

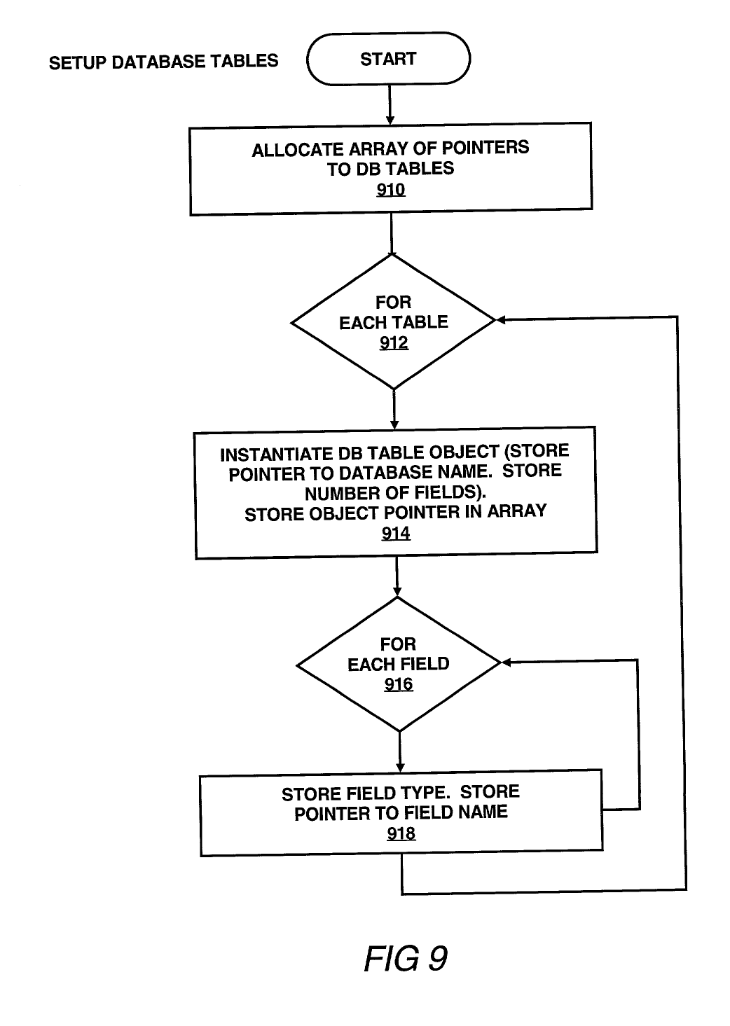

FIG. 9 illustrates an exemplary flow diagram for the database table set-up process referred to in step 704 of FIG. 7 in accordance with an embodiment of the present invention. These database tables are comprised of a number of fields or records, each of which may be used to store a particular piece of information. One example of a common database table includes an address book comprised of a first name field, a last name field, an address field and a telephone number field. Embodiments of the present invention contemplate that these tables may be designed by an application program developer and implemented on, for example, the client 100.

Accordingly, the run-time engine 102 may be configured to allocate an array of pointers to the database tables utilized by the application program (step 910). Subsequently, for each table (step 912), the run-time engine 102 may be configured to instantiate a database table object for each table (step 914). As mentioned above, the table object includes a database name as well as the number of fields.

The run-time engine 102 may be configured to examine each individual field of the database table (step 916). For each individual field, the run-time engine 102 may be configured to store a value indicating the type of the particular field as well as a pointer to the field name (step 918). Examples of field type include string, integer, date, time, money, and the like. Examples of field name include descriptions of the type of information or data to be stored in the field. Advantageously, by utilizing the database_table class 204 described above to model client 100 objects, information such as field type and field name may be included with the actual data in client 100.

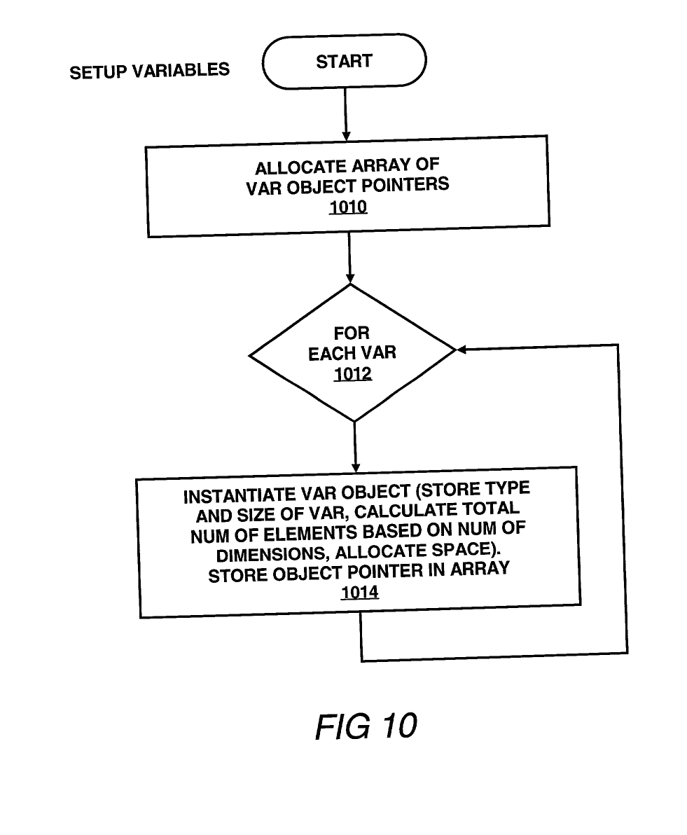

FIG. 10 illustrates an exemplary flow diagram of the process to SETUP VARIABLES referred to in step 708 of FIG. 7 in accordance with an embodiment of the present invention. As shown in FIG. 10, the run-time engine 102 may be configured to allocate memory space for an array of variable object pointers (step 1010). The variables may be scalar or combinations of different types of variables such as strings, integers, dates, times, and the like.

The run-time engine 102 may be configured to examine each variable (step 1012). The run-time engine 102 may be also configured to instantiate a variable object, storing the type and size of the variable (step 1014). In addition, the total number of elements based on the number of dimensions and allocated space may be calculated.

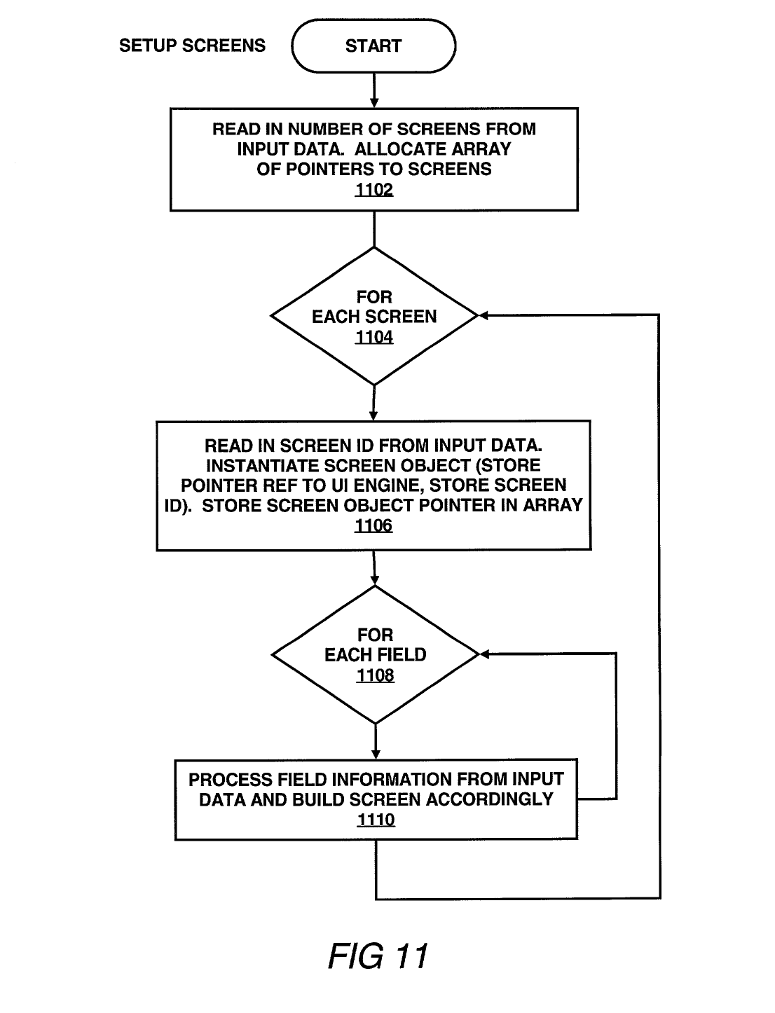

FIG. 11 illustrates an exemplary flow diagram for a SETUP SCREEN process referred to in step 706 of FIG. 7 in accordance with an embodiment of the present invention. As shown in FIG. 11, the run-time engine 102 may be configured to dynamically allocate one or more screens associated with the selected application program. In particular, the screens of the selected application program are to be generated during run-time, i.e., ‘on-the-fly’ or after compile time. Specifically, the run-time engine 102 may be also configured to allocate an array of pointers, each pointer pointing to each of the screens as identified from the input data read from the application program file (step 1102).

The run-time engine 102 may be configured to examine each screen (step 1104). For each screen, the run-time engine 102 may be configured to instantiate a corresponding screen object (step 1106). The instantiated screen objects may be configured to store information such as a screen ID and all information to be displayed including menus, labels, edits boxes, and the like.

After instantiating the screen objects, as will be discussed below, the run-time engine 102 may be configured to examine each field of the instantiated screen object (step 1108). For each field, the run-time engine 102 may be configured to process field information from the application program file and add to a corresponding screen object, leading to the construction of each screen (step 1110).

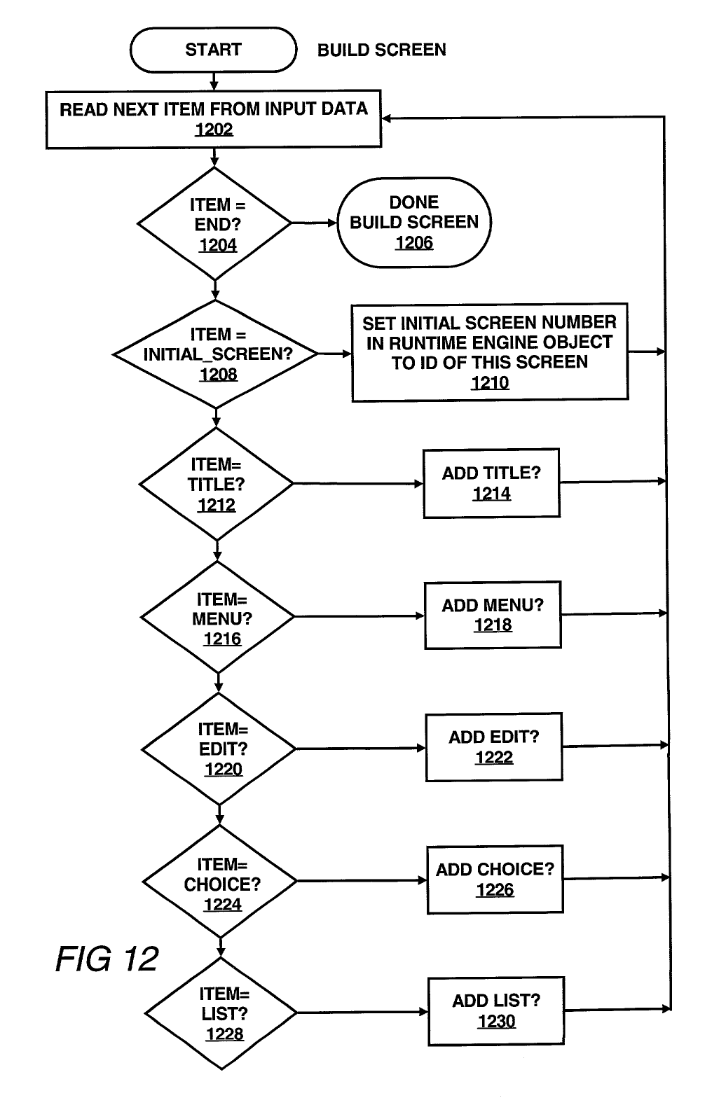

FIG. 12 illustrates a more detailed exemplary flow diagram of the BUILD SCREEN process referred to in step 1110 of FIG. 11 in accordance with an embodiment of the present invention. As shown in FIG. 12, the run-time engine 102 may be configured to build a screen by reading an item or tag from the input data retrieved from the code block of the application program (step 1202).

The run-time engine 102 may be configured to determine whether the retrieved item is an END item (step 1204), which indicates that the screen is complete. If the retrieved item is an END item, the run-time engine 102 may be configured to end processing of the building of the screen (step 1206). Otherwise, the run-time engine 102 may be configured to determine whether the retrieved item is an INITIAL_SCREEN item (step 1208), which may be configured to identify the current screen as being the first screen to be displayed on the display 105 of the client 100.

If the run-time engine 102 determines that the retrieved item is an INITIAL_SCREEN item, the run-time engine 102 may be configured to set initial screen number to the ID of the INITIAL_SCREEN item (Step 1210).

Otherwise, the run-time engine 102 may be configured to determine whether the retrieved item is a TITLE item (step 1212). The TITLE item may be configured to indicate that a title or screen name is to be added to the current screen.

If the run-time engine 102 determines that the retrieved item is a TITLE item, the run-time engine 102 may be configured to add the TITLE item to the current screen on the display 105 of the client 100 (step 1214). Otherwise, the run-time engine 102 may be configured to determine whether the retrieved item is a MENU item (step 1216).

If the run-time engine 102 determines that the retrieved item is a MENU item, the run-time engine 102 may be configured to add the MENU item to the current screen (step 1218). Otherwise, the run-time engine 102 may be also configured to determine whether the retrieved item is a EDIT item (step 1220).

If the run-time engine 102 determines that the retrieved item is an EDIT item, the run-time engine 102 may be configured to add the EDIT item to the current screen (step 1222). Otherwise, the run-time engine 102 may be also configured to determine whether the retrieved item is a CHOICE item (step 1224).

If the run-time engine 102 determines that the retrieved item is a CHOICE item, the run-time engine 102 may be configured to add the CHOICE item to the current screen (step 1226). Otherwise, the run-time engine 102 may determine that the retrieved item is a LIST item (LIST item to the current screen (step 1230) and the run-time engine 102 may be configured to return to the processing of step 1202.

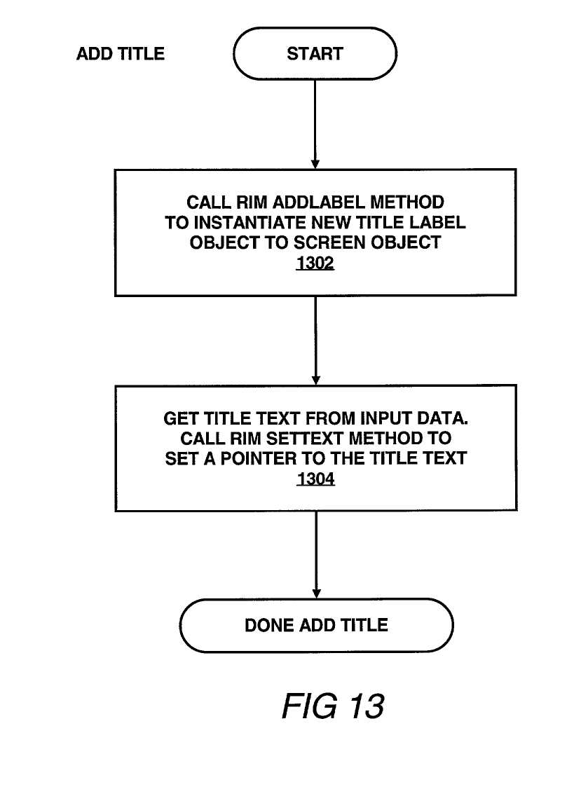

FIG. 13 illustrates a more detailed exemplary flow diagram of the ADD TITLE process referred to in step 1214 of FIG. 12 in accordance with an embodiment of the present invention. As shown in FIG. 13, the run-time engine 102 may be configured to execute a RIM Addlabel method to instantiate a new title label object to the current screen (step 1302). Subsequently, the run-time engine 102 may be also configured to retrieve the actual string or text string from the input data block of the application program. The run-time engine 102 may be further configured to set a point to the amended title by calling, for example, a RIM SetText method (step 1304).

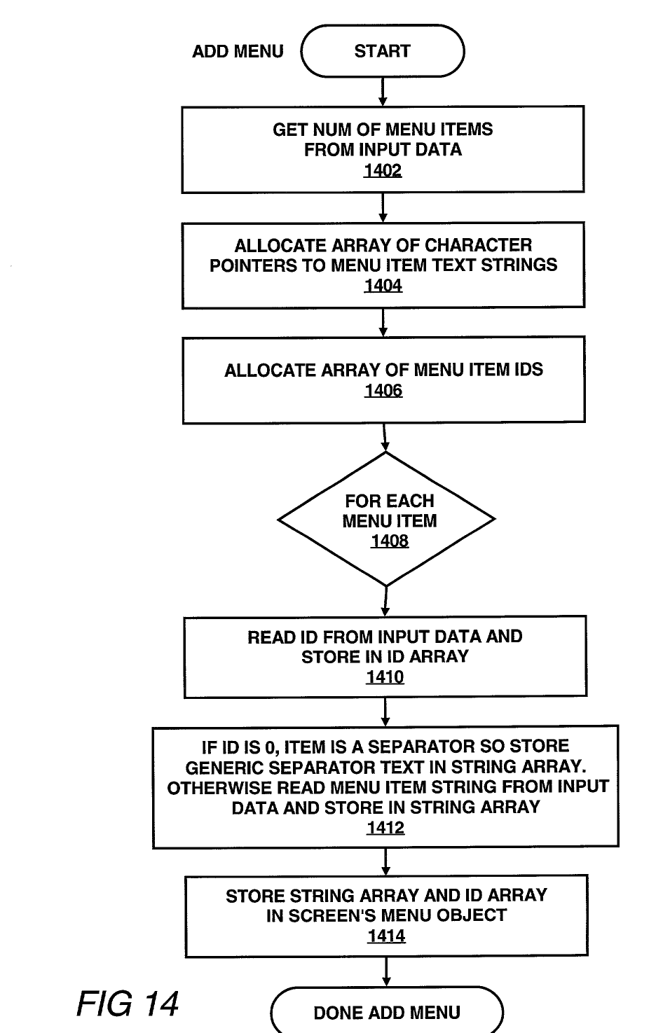

FIG. 14 illustrates an exemplary flow diagram for an ADD MENU process referred to in step 1218 of FIG. 12 in accordance with an embodiment of the present invention. As shown in FIG. 14, the run-time engine 102 may be configured to retrieve a number of menu items from the input data block section of the selected application program (step 1402). The run-time engine 102 may be also configured to allocate an array in the memory of the client 100. The array may be configured to provide storage of character pointers to menu item ext strings (step 1404).

The run-time engine 102 may be further configured to allocate a second array for menu item ID(s) (step 1406). The run-time engine 102 may be yet further configured to examine each menu item (step 1408). An ID may be retrieved from the input data block of the selected application program and stored in the second array by the run-time engine 102 (step 1410).

The run-time engine 102 may be yet further configured to determine whether the ID of the retrieved item is set to zero (step 1412). If the ID is set to zero and therefore constitutes a non-separator menu item, such as a FILE or OPEN item, a generic separator text is stored in the first array by the run-time engine 102. If the ID is not set to zero, a menu item string from the input data block of the selected application program is read and stored in the first array by the run-time engine 102.

After all the menu items are processed, the run-time engine 102 may be configured to store the first and second array in the screen menu object (step 1414) and the run-time engine 102 exits.

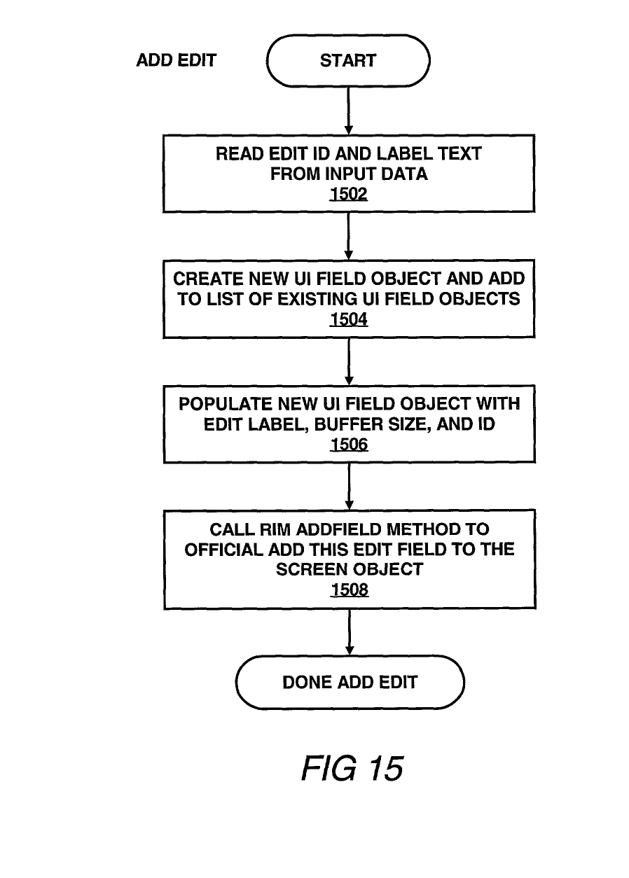

FIG. 15 illustrates an exemplary flow diagram of an ADD EDIT referred to in step 1222 of FIG. 12 in accordance with an embodiment of the present invention. As shown in FIG. 15, the run-time engine 102 may be configured to read an edit box ID and a label text form the input data section of the selected application program (step 1502). The run-time engine 102 may be also configured to instantiate a new ui_field_object from the ui_field_class 214 and add the newly instantiated object to an existing list of ui_field₁₃ objects (step 1504).

After instantiation, the run-time engine 102 may be configured to populate the newly instantiated ui_field_object with an edit box label, buffer size, and edit box ID (step 1506). The run-time engine 102 may be also configured to call the RIM AddField method to add the newly created edit field to the screen object (step 1508).

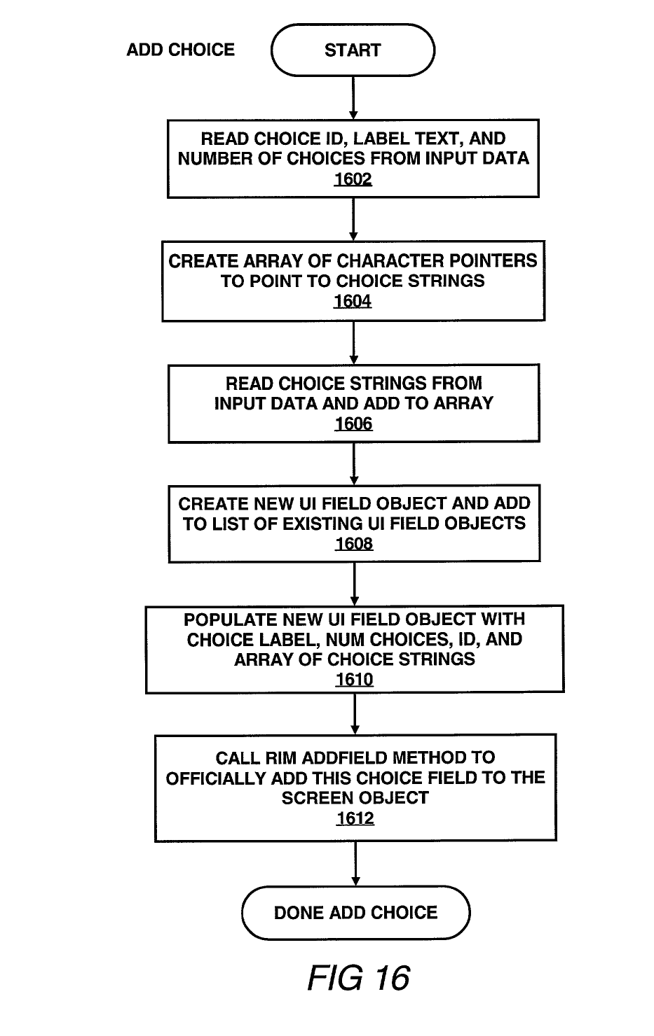

FIG. 16 illustrates an exemplary flow diagram for an ADD CHOICE processing referred to in step 1226 of FIG. 12 in accordance with an embodiment of the present invention. In particular, the run-time engine 102 may be configured to retrieve CHOICE box ID, a label text, and a number of choices from the input data block of the selected application program (step 1602). The run-time engine 102 may be also configured to allocate an array of character pointers, each pointer point to a CHOICE string provided by this CHOICE box (step 1604).

The run-time engine 102 may be further configured to retrieve the CHOICE strings from the input data block of the selected application program and added to the newly allocated array (step 1606). The run-time engine 102 may be yet further configured to instantiate a new ui_field_object from the ui_field_class 216 and added to a list of existing user interface field objects (step 1608).

The run-time engine 102 may be yet further configured to populate the newly created ui_field_object with the retrieved choice label, number of choices, box ID, and array of choice strings (step 16 10). Then the CHOICE box may be added to the screen object using, for example, a RIM AddField method (step 1612) by the run-time engine 102.

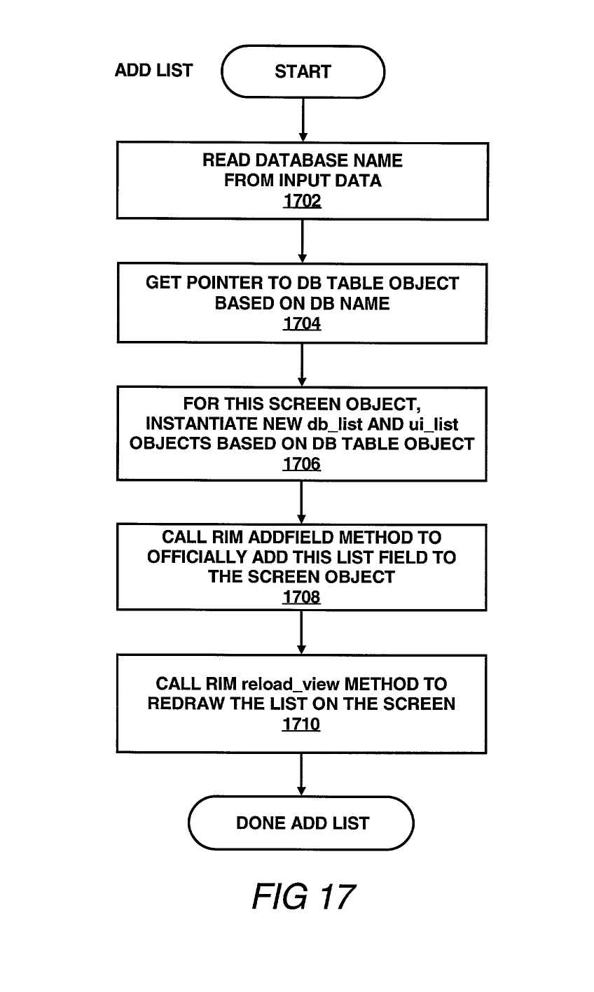

FIG. 17 illustrates an exemplary flow diagram of an ADD LIST process referred to in step 1230 of FIG. 12 in accordance with an embodiment of the present invention. More specifically, the run-time engine 102 may be configured to retrieve a database name from the input data block of the selected application program (step 1702). The run-time engine 102 may utilize the database name to set a pointer to the retrieved database (step 1704).

The run-time engine 102 may be further configured to instantiate a db_list object and a ui_list object for use in displaying a list on the screen (step 1706). The list is added to the screen object using, for example, a RIM AddField method (step 1708) by the run-time engine 102. Finally, the run-time engine 102 the list is refreshed or redrawn using, for example, a RIM reload_view method (step 1710) to reflect any possible changes to the list.

As mentioned above, it is envisioned that any of a number of events may result in or cause the execution of one or more code blocks by run-time engine 102 during processing of the GO method of FIG. 6. More particularly, each event may be associated with one or more code blocks with the application program thereby being divided into any number of code blocks. Each code block, in turn, may have a unique ID number and contain a sequential list of op codes and parameter information. As one example, a first code block may be executed at startup and typically contains variable initialization requests. Following the execution of this first code block, control is passed to the event or GO loop of FIG. 6. Additional code blocks may then be executed as events dictate by cross-checking each event to determine if an associated code block exists.

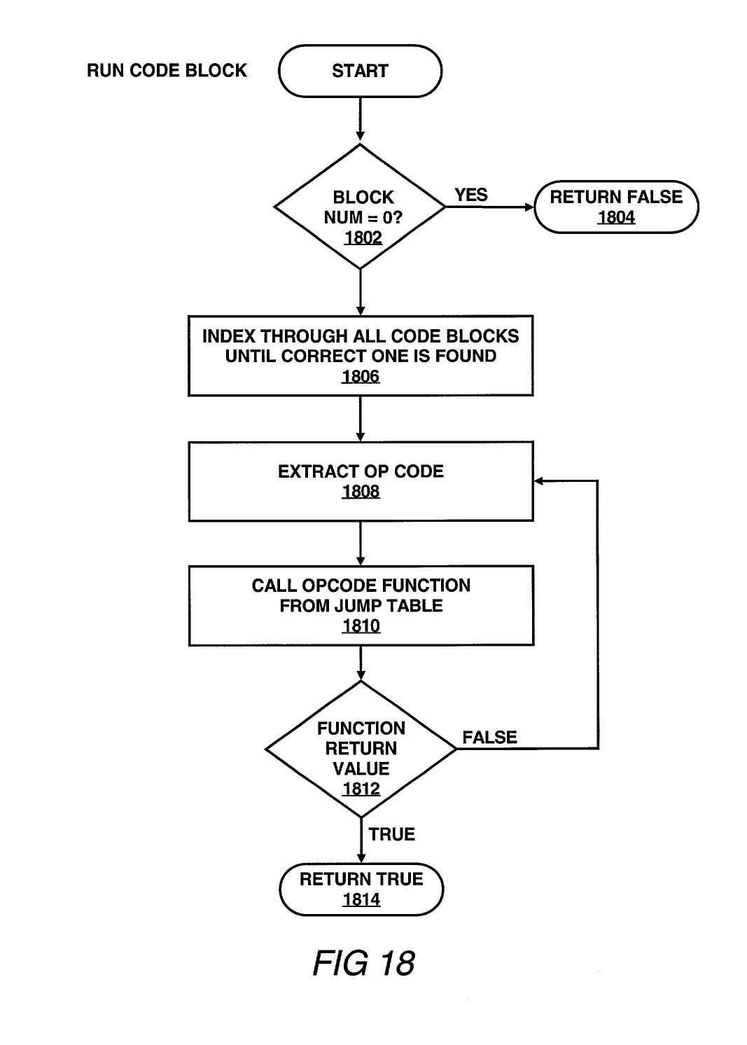

FIG. 18 illustrates an exemplary flow diagram of a RUN CODE BLOCK process referred to in step 618 of FIG. 6 in accordance with an embodiment of the present invention. As shown in FIG, 18, run-time engine 102 may be configured determine whether the code block number is zero (step 1802). If the run-time engine 102 determines that the code block number is set to zero, the run-time engine 102 may return a false value indicating that no code was executed (step 1804). This is because, in this example, a code block with an ID of zero indicates a special situation. In particular, if this function was called with a code block number of zero it may indicated that an event happened for which there is no corresponding code block. This is a normal condition that may happen from time to time.

Otherwise if the code block number is not set to zero, the run-time engine 102 may be also configured to search through all of the code blocks until the matching block is located (step 1806). After locating the matching block, run-time engine 102 may be further configured to extract op codes from the code block (step 1808). With each op code, the run-time engine 102 calls a jump table using the op code as an index to a specific function (step 1810). This function may then read and process any parameter information and perform the desired task. If the task includes, for example, a user interface form change, program termination, or if it is the last task of the current code block (step 1812), a value of true is returned (step 1814). A true return value causes run-time engine 102 to terminate processing op codes from the current code block and to draw a new form, terminate the program, or reenter the event loop. A false return value (step 1812) cause run-time engine 102 to read and process the next op code of the code block.

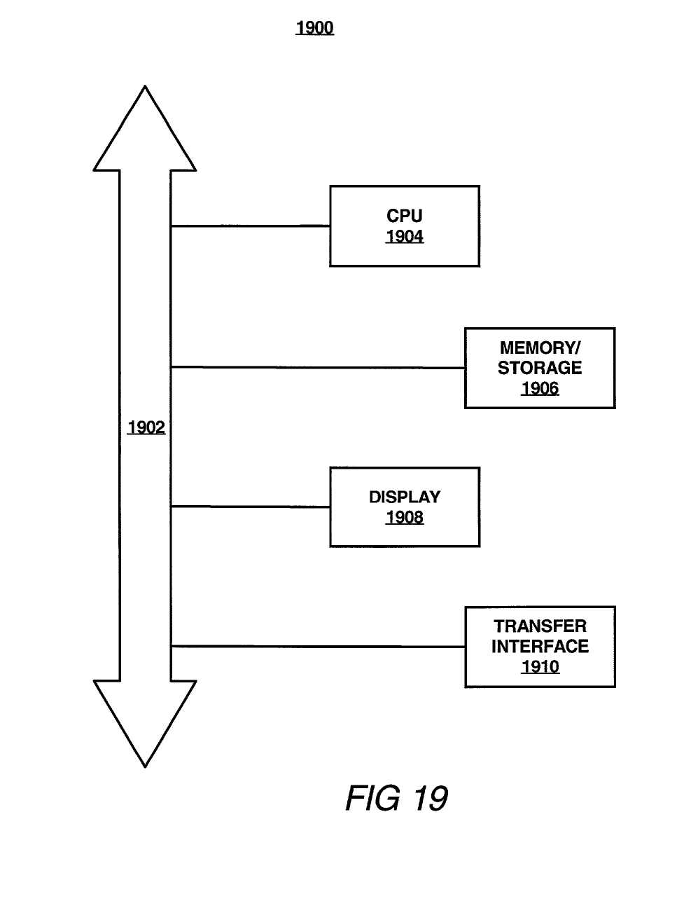

FIG. 19 illustrates an exemplary computing platform 1900 where embodiments of the present invention may be practiced. In particular, embodiments of the present invention contemplate that various portions of software for implementing the various aspects of the present invention as previously described can reside in memory/storage device 1906.

A display device 1908 is also shown, which could be any number of devices conveying visual and/or audio information to a user. Also in communication with bus 1902 is a transfer interface 1910 for allowing device 1900 to interface with other devices.

In general, it should be emphasized that the various components of embodiments of the present invention can be implemented in hardware, software, or a combination thereof. In such embodiments, the various components and steps would be implemented in hardware and/or software to perform the functions of the present invention. Any presently available or future developed computer software language and/or hardware components can be employed in such embodiments of the present invention. For example, at least some of the functionality mentioned above could be implemented using C, C++, or Visual Basic (Microsoft) programming languages.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

What is claimed is:

1. A method for executing application programs, comprising:
receiving at least one application program in a client device;
activating said at least one application program;
instantiating a run-time engine; and
executing said at least one application program by said run-time engine.

2. The method according to claim 1, further comprising:
registering said at least one application program with an operating system of said client device; and
displaying an icon configured to represent said at least one application program in response to said registration.

3. The method according to claim 1, further comprising:
registering a process identification corresponding to said activated said at least one application program; and
executing a GO method by said run-time engine.

4. The method according to claim 3, wherein said GO method comprises:
initializing at least one of the following of a jump table, a database table, a screen, and a variable;
setting a current screen identification to a first screen; and
testing said current screen identification.

5. The method according to claim 4, further comprising:
ending said GO method in response to said current screen identification being set to zero.

6. The method according to claim 4, further comprising:
retrieving a pointer to a current screen corresponding to said current screen identification;
executing a before-draw code block for said current screen; and
determining a change in said current screen.

7. The method according to claim 6, further comprising:
determining whether said current screen identification being set to zero in response to said determination of said change in said current screen; and
terminating said GO method in response to said current screen identification being set to zero.

8. The method according to claim 6, further comprising:
drawing said screen in response to said determination of said change being a no-change;
receiving a menu selection; and
executing a corresponding code block for said menu selection.

9. The method according to claim 6, wherein said execution of said corresponding code block comprises:
determining a code block number of said corresponding code block; and
returning a false value in response to said determination of said code block number being zero.

10. The method according to claim 9, further comprising:
searching a plurality of code blocks in response to said determination of said code block being non-zero;
retrieving said corresponding code block in response to said code block number; and
extracting associated opcodes from said corresponding code block.

11. The method according to claim 10, further comprising:
extracting an opcode from said associated opcodes; and
executing a corresponding function of said opcode from a jump table.

12. The method according to claim 11, further comprising:
terminating said corresponding code block in response to said corresponding function returning a true value.

13. A system for executing application programs, comprising:
a client device, said client device comprises a memory and a processor; and
a run-time engine residing in said memory and executing on said processor, wherein said client is configured to receive at least one application program and is also configured to instantiating said run-time engine in response to an activation of said at least one application program and is further configured to execute said at least one application program by said run-time engine.

14. The system according to claim 13, wherein said client device is further configured to register said at least one application program with an operating system of said client device; and is yet further configured to display an icon configured to represent said at least one application program in response to said registration.

15. The system according to claim 13, wherein said client device is further configured to register a process identification corresponding to said activated said at least one application program and said run-time engine is configured to execute a GO method.

16. The system according to claim 15, wherein said GO method comprises:
initializing at least one of the following of a jump table, a database table, a screen, and a variable;
setting a current screen identification to a first screen; and
testing said current screen identification.

17. The system according to claim 16, wherein said GO method further comprises:
ending said GO method in response to said current screen identification being set to zero.

18. The system according to claim 16, wherein said GO method further comprises:
retrieving a pointer to a current screen corresponding to said current screen identification;
executing a before-draw code block for said current screen; and
determining a change in said current screen.

19. The system according to claim 18, wherein said GO method further comprises:
determining whether said current screen identification being set to zero in response to said determination of said change in said current screen; and
terminating said GO method in response to said current screen identification being set to zero.

20. The system according to claim 18, wherein said GO method further comprises:
drawing said screen in response to said determination of said change being a no-change;
receiving a menu selection; and
executing a corresponding code block for said menu selection.

21. The system according to claim 18, wherein said execution of said corresponding code block comprises:
determining a code block number of said corresponding code block; and
returning a false value in response to said determination of said code block number being zero.

22. The system according to claim 21, wherein said execution of said corresponding code block comprises:
searching a plurality of code blocks in response to said determination of said code block being non-zero;
retrieving said corresponding code block in response to said code block number; and
extracting associated opcodes from said corresponding code block.

23. The system according to claim 22, wherein said execution of said corresponding code block comprises:
extracting an opcode from said associated opcodes; and
executing a corresponding function of said opcode from a jump table.

24. The system according to claim 23, wherein said execution of said corresponding code block comprises::
terminating said corresponding code block in response to said corresponding function returning a true value.

25. A computer readable storage medium on which is embedded one or more computer programs, said one or more computer programs implementing a method of executing application programs, said one or more computer programs comprising a set of instructions for:
receiving at least one application program in a client device;
activating said at least one application program;
instantiating a run-time engine; and
executing said at least one application program by said run-time engine.

26. The computer readable storage medium in according to claim 25, said one or more computer programs further comprising a set of instructions for:
registering said at least one application program with an operating system of said client device; and
displaying an icon configured to represent said at least one application program in response to said registration.

27. The computer readable storage medium in according to claim 25, said one or more computer programs further comprising a set of instructions for:
registering a process identification corresponding to said activated said at least one application program; and
executing a GO method by said run-time engine.

28. The computer readable storage medium in according to claim 27, said one or more computer programs further comprising a set of instructions for:
initializing at least one of the following of a jump table, a database table, a screen, and a variable;
setting a current screen identification to a first screen; and
testing said current screen identification.

29. The computer readable storage medium in according to claim 28, said one or more computer programs further comprising a set of instructions for:
ending said GO method in response to said current screen identification being set to zero.

30. The computer readable storage medium in according to claim 28, said one or more computer programs further comprising a set of instructions for:
retrieving a pointer to a current screen corresponding to said current screen identification;
executing a before-draw code block for said current screen; and
determining a change in said current screen.

31. The computer readable storage medium in according to claim 30, said one or more computer programs further comprising a set of instructions for:
determining whether said current screen identification being set to zero in response to said determination of said change in said current screen; and
terminating said GO method in response to said current screen identification being set to zero.

32. The computer readable storage medium in according to claim 30, said one or more computer programs further comprising a set of instructions for:
drawing said screen in response to said determination of said change being a no-change;
receiving a menu selection; and
executing a corresponding code block for said menu selection.

33. The computer readable storage medium in according to claim 30, said one or more computer programs further comprising a set of instructions for said execution of said corresponding code block comprises:
determining a code block number of said corresponding code block; and
returning a false value in response to said determination of said code block number being zero.

34. The computer readable storage medium in according to claim 33, said one or more computer programs further comprising a set of instructions for said execution of said corresponding code block comprises:
searching a plurality of code blocks in response to said determination of said code block being non-zero;
retrieving said corresponding code block in response to said code block number; and
extracting associated opcodes from said corresponding code block.

35. The computer readable storage medium in according to claim 34, said one or more computer programs further comprising a set of instructions for said execution of said corresponding code block comprises:
extracting an opcode from said associated opcodes; and
executing a corresponding function of said opcode from a jump table.

36. The computer readable storage medium in according to claim 35, said one or more computer programs further comprising a set of instructions for said execution of said corresponding code block comprises:
terminating said corresponding code block in response to said corresponding function returning a true value.
